(19) United States
(12) Patent Application Publication
(10) Pub. No.: US 2025/0284879 A1
(43) Pub. Date: Sep. 11, 2025

(54) SENTENCE GENERATION APPARATUS, SENTENCE GENERATION METHOD, AND STORAGE MEDIUM

(71) Applicant: Shintaro Kawamura, KANAGAWA (JP)

(72) Inventor: Shintaro Kawamura, KANAGAWA (JP)

(73) Assignee: Ricoh Company, Ltd., Tokyo (JP)

(21) Appl. No.: 19/062,478

(22) Filed: Feb. 25, 2025

(30) Foreign Application Priority Data
Mar. 6, 2024 (JP) 2024-033652
Nov. 14, 2024 (JP) 2024-198810

(51) Int. Cl. G06F 40/166; G06F 16/334; G06F 40/289; G06F 40/35

(52) U.S. Cl. CPC G06F 40/166; G06F 16/3344; G06F 40/289; G06F 40/35

(57) ABSTRACT

A sentence generation apparatus includes processing circuitry. The processing circuitry searches for related information on an input character string. The processing circuitry generates a set of sentences based on the input character string and the related information. The processing circuitry determines a relation between the set of sentences and the related information. The processing circuitry processes a set of output sentences including the set of sentences based on a result of the determination. The processing circuitry outputs the processed set of output sentences.

### CROSS-REFERENCE TO RELATED APPLICATIONS

This patent application is based on and claims priority pursuant to 35 U.S.C. § 119(a) to Japanese Patent Application No. 2024-033652, filed on Mar. 6, 2024, and No. 2024-198810, filed on Nov. 14, 2024, in the Japan Patent Office, the entire disclosure of which is hereby incorporated by reference herein.

### BACKGROUND

### Technical Field

The present disclosure relates to a sentence generation apparatus, a sentence generation method, and a storage medium.

### Related Art

A technique is known that automatically generates a subsequent sentence or an answer sentence based on an input sentence from a user. For example, generative artificial intelligence (AI) based on a large language model, such as ChatGPT, is thriving.

### SUMMARY

Embodiments of the present disclosure described herein provide a novel sentence generation apparatus includes processing circuitry. The processing circuitry searches for related information on an input character string. The processing circuitry generates a set of sentences based on the input character string and the related information. The processing circuitry determines a relation between the set of sentences and the related information. The processing circuitry processes a set of output sentences including the set of sentences based on a result of the determination. The processing circuitry outputs the processed set of output sentences.

Embodiments of the present disclosure described herein provide a novel sentence generation method executed by a computer. The method includes: searching for related information on an input character string; generating a set of sentences based on the input character string and the related information; determining a relation between the set of sentences and the related information; processing a set of output sentences including the set of sentences based on a result of the determining; and outputting the processed set of output sentences.

Embodiments of the present disclosure described herein provide a novel non-transitory storage medium storing computer-readable program code that, when executed by a computer, causes the computer to perform a method. The method includes: searching for related information on an input character string; generating a set of sentences based on the input character string and the related information; determining a relation between the set of sentences and the related information; processing a set of output sentences including the set of sentences based on a result of the determining; and outputting the processed set of output sentences.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an information processing system according to an embodiment of the present disclosure;

FIG. 2 is a diagram illustrating a hardware configuration of a sentence generation apparatus according to an embodiment of the present disclosure;

FIG. 3 is a diagram illustrating a functional configuration of an information processing system according to an embodiment of the present disclosure;

FIG. 4 is a flowchart of a processing procedure executed by the sentence generation apparatus of FIG. 2;

FIG. 5 is a diagram illustrating a first display example of a set of output sentences that has been processed;

FIG. 6 is a diagram illustrating a second display example of a set of output sentences that has been processed;

FIG. 7 is a diagram illustrating a third display example of a set of output sentences that has been processed;

FIG. 8 is a diagram illustrating a fourth display example of a set of output sentences that has been processed;

FIG. 9 is a diagram illustrating a fifth display example of a set of output sentences that has been processed; and

FIG. 10 is a diagram illustrating a sixth display example of a set of output sentences that has been processed.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

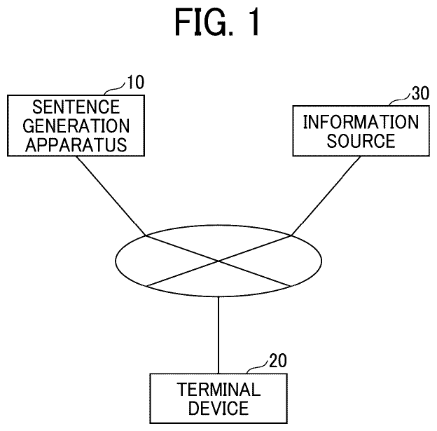

A description is given below of embodiments of the present disclosure with reference to the drawings. FIG. 1 is a diagram illustrating a configuration of an information processing system according to an embodiment of the present disclosure. In FIG. 1, the information processing system includes a sentence generation apparatus 10, a terminal device 20, and an information source 30. The sentence generation apparatus 10, the terminal device 20, and the information source 30 are communicably connected to each other through a network such as a local area network (LAN) or the Internet.

The terminal device 20 is a terminal device used by a user. For example, a personal computer (PC), a smartphone, or a tablet terminal may be used as the terminal device 20.

The sentence generation apparatus 10 is one or more computers that generate a sentence corresponding to a sentence input by the user in the terminal device 20.

The information source 30 is one or more computers that store various kinds of information. For example, the information source 30 may be a computer group that stores information to be searched on the Internet.

The sentence generation apparatus 10 may be included in the terminal device 20. In other words, the terminal device 20 may also serve as the sentence generation apparatus 10.

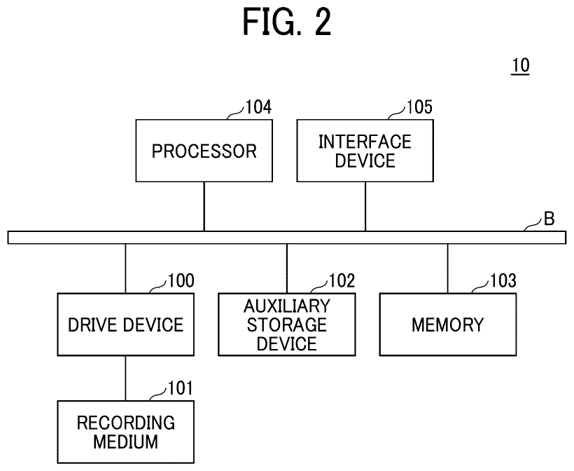

FIG. 2 is a diagram illustrating a hardware configuration of the sentence generation apparatus 10 according to an embodiment of the present disclosure. The sentence generation apparatus 10 of FIG. 2 includes a drive device 100, an auxiliary storage device 102, a memory 103, a processor 104, and an interface device 105 and these devices and units are connected to each other through a bus B.

A program that implements processing of the sentence generation apparatus 10 is provided by a recording medium 101 such as a compact disc read-only memory (CD-ROM). When the recording medium 101 storing the program is set in the drive device 100, the program is installed in the auxiliary storage device 102 from the recording medium 101 through the drive device 100. Alternatively, the program may be downloaded from another computer through a network, instead of being installed from the recording medium 101. The auxiliary storage device 102 stores the installed program and also stores files and data to be used.

In response to an instruction to activate a program, the memory 103 reads the program from the auxiliary storage device 102 and stores the program. The processor 104 is a central processing unit (CPU) alone or a graphics processing unit (GPU) alone, or both of a CPU and a GPU, and executes functions relating to the sentence generation apparatus 10 according to the program stored in the memory 103. The interface device 105 is used for connecting the sentence generation apparatus 10 to a network.

The terminal device 20 may also have hardware as illustrated in FIG. 2.

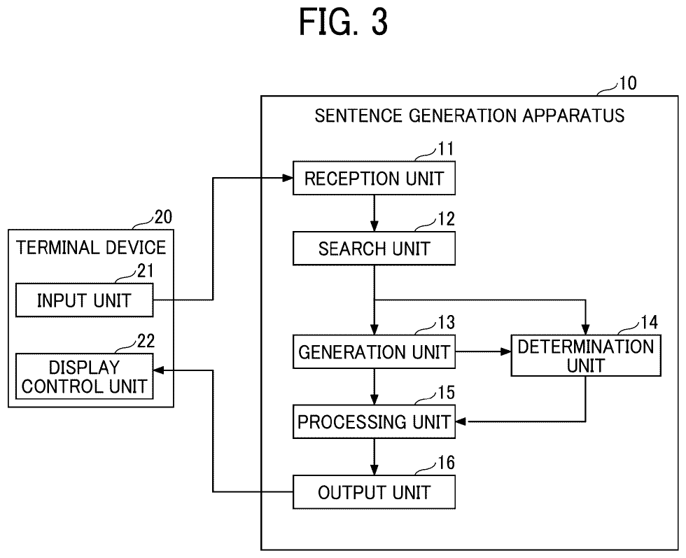

FIG. 3 is a diagram illustrating a functional configuration of the information processing system according to an embodiment of the present disclosure. In FIG. 3, the terminal device 20 includes an input unit 21 and a display control unit 22. Each of the input unit 21 and the display control unit 22 is implemented by a processor of the terminal device 20 executing one or more programs installed on the terminal device 20.

The sentence generation apparatus 10 includes a reception unit 11, a search unit 12, a generation unit 13, a determination unit 14, a processing unit 15, and an output unit 16. Each of the above-mentioned functional units is implemented by the processor 104 executing one or more programs installed on the sentence generation apparatus 10.

The input unit 21 of the terminal device 20 receives an input of a character string that is a source of generation of a sentence from the user. The character string may be, for example, a natural sentence in a natural language or a word. In the following descriptions, the character string is referred to as a “question sentence.” The input unit 21 transmits an input question sentence to the sentence generation apparatus 10.

The display control unit 22 displays a set of sentences generated by the sentence generation apparatus 10 based on the question sentence. The set of sentences refers to an ordered set of one or more sentences.

The reception unit 11 receives the question sentence transmitted from the terminal device 20 and searches the information source 30 for related information on the question sentence. The related information on the question sentence refers to information related to the question sentence. The search for the related information on the question sentence may be performed by using a known search technique with the question sentence as a query. The related information may be an information source of the sentence to be generated.

The generation unit 13 generates a set of sentences based on the question sentence and the related information by using a large language model which is a machine learning model that has learned a language model in advance. In the following descriptions, the large language model is simply referred to as an LLM. A set of sentences generated by the generation unit 13 is referred to as a generated sentence set or a set of generated sentences.

The determination unit 14 determines the relation with the related information for each predetermined unit (in the following descriptions, referred to as a “verification unit”) composing the generated sentence set generated by the generation unit 13. The verification unit is, for example, a sentence or a phrase. Alternatively, a set of two or more sentences may be set as the predetermined unit. The relation between the generated sentence set and the related information indicates the semantic closeness between the generated sentence set and the related information. The relation between the generated sentence set and the related information may be the presence or absence of an implication relation, the degree of coincidence of words, or the degree of similarity. In the following descriptions, the determination of the relation between the generated sentence set and the related information may be referred to as determination of whether the relationship is based on the related information. The result of the determination that the predetermined unit composing the generated sentence set and the related information have a relation (strong relation) with each other is a result of the determination in a case where there is an implication relation between the two, the degree of coincidence of words between the two is equal to or larger than a threshold, or the degree of similarity between the two is equal to or larger than a threshold. In the following descriptions, the result of the determination that there is a relation (strong relation) between the predetermined unit composing the generated sentence set and the related information may be referred to as being based on the related information. The result of the determination that the predetermined unit composing the generated sentence set and the related information have no relation (weak relation) is a result of the determination in a case where there is no implication relation between the two, the degree of coincidence of words between the two is equal to or less than a threshold, or the degree of similarity between the two is equal to or less than a threshold. In the following descriptions, the result of the determination that there is no relation (weak relation) between the predetermined unit composing the generated sentence set and the related information may be referred to as not being based on the related information.

The processing unit 15 processes the set of output sentences including the set of sentences generated by the generation unit 13 based on the result of the determination by the determination unit 14. For example, the processing unit 15 deletes, from the set of sentences, a predetermined unit determined not to be based on related information. Alternatively, the processing unit 15 changes the form of a portion corresponding to a predetermined unit determined not to be based on related information, to a form different from that of other portions in the set of sentences. The set of output sentences is a set of sentences to be output to the terminal device 20. The set of output sentences may be only a set of sentences (generated sentence set) generated by the generation unit 13 or may include related information. The set of output sentences may be referred to as an output sentence set.

The output unit 16 outputs (transmits) the set of output sentences including the set of sentences generated by the generation unit 13 to the terminal device 20. When the processing is performed by the processing unit 15, the output unit 16 outputs the processed set of output sentences.

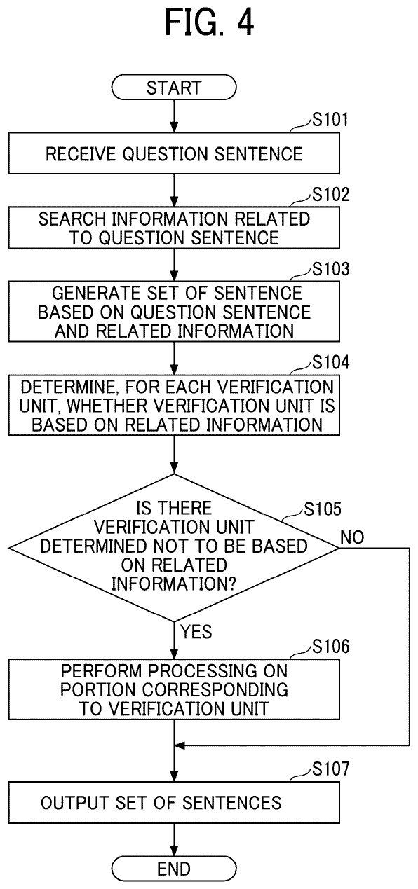

A description is given below of a processing procedure executed by the sentence generation apparatus 10. FIG. 4 is a flowchart of a processing procedure executed by the sentence generation apparatus 10.

In step S101, the reception unit 11 receives a question sentence, which is input by the user through the input unit 21 of the terminal device 20, from the input unit 21.

Subsequently, in step S102, the search unit 12 retrieves (acquires) the related information on the question sentence from the information source 30 using the question sentence as a query. The related information may be a part of information having a high search score among information acquired as a search result.

Subsequently, in step S103, the generation unit 13 generates a set of sentences (in the following descriptions, referred to as a “generated sentence set”) based on the question sentence and the related information. For example, the generation unit 13 generates a prompt based on the question sentence and the related information, and inputs the prompt to the LLM. The generation unit 13 acquires a set of sentences output from the LLM in response to the input of the prompt. The content of the prompt may be, for example, a natural sentence indicating that an answer to the question sentence is generated using the related information.

Subsequently, in step S104, the determination unit 14 determines, for each verification unit (e.g., for each sentence) of the generated sentence set, whether the verification unit is based on the related information. For example, the recognizing textual entailment is used for the determination. Specifically, the determination unit 14 performs, for each verification unit, the recognizing textual entailment with each unit corresponding to the verification unit in the related information (in the following descriptions, referred to as “corresponding unit”), and determines that a verification unit having an implication relation to a corresponding unit is based on the related information, and determines that a verification unit having no implication relation to a corresponding unit is not based on the related information. Alternatively, the determination unit 14 calculates the degree of coincidence of words between each verification unit and each corresponding unit, determines that a verification unit having a degree of coincidence equal to or larger than a threshold with respect to a corresponding unit is based on the related information, and determines that a verification unit having a degree of coincidence smaller than the threshold with respect to the corresponding unit is not based on the related information. Alternatively, the determination unit 14 calculates, for each verification unit, the similarity (e.g., cosine similarity) between the embedding vector of the verification unit and the embedding vector of each correspondence unit, and determines that a verification unit having a similarity equal to or larger than a threshold with respect to a correspondence unit is based on the related information, and determines that a verification unit having a similarity smaller than the threshold with respect to the correspondence unit is not based on the related information. The determination may be performed using other known techniques. The determination may be performed using the LLM used by the generation unit 13 to generate a set of sentences.

Subsequently, in step S105, the processing unit 15 determines whether there is a verification unit determined not to be based on the related information in the determination result by the determination unit 14. When there is no verification unit determined not to be based on the relation information (NO in step S105), the operation proceeds to step S107. When there is a verification unit determined not to be based on the relation information (YES in step S105), in step S106, the processing unit 15 executes predetermined processing on a portion corresponding to the verification unit determined not to be based on the related information in the generated sentence set. For example, the processing unit 15 deletes the corresponding portion in the set of output sentences. Alternatively, the processing unit 15 makes the form of the corresponding portion in the set of output sentences different from that of the other portions. The form may be, for example, a shape (such as font) of a character, or the presence or absence of modification for emphasis such as an underline or a change of a background color. The processing of the set of output sentences by the processing unit 15 may be performed on the generated sentence set or may be performed on the related information. The processing unit 15 may perform a predetermined processing on a portion corresponding to the verification unit determined not to be based on the related information in the generated sentence set. Alternatively, the processing unit 15 may perform a predetermined processing on a portion corresponding to the verification unit determined to be based on the related information. Alternatively, the processing unit 15 may perform a predetermined processing on a portion corresponding to the corresponding unit of the related information, which contributes to the determination of the verification unit determined to be based on the related information.

Subsequently, in step S108, the output unit 16 outputs the set of output sentences. At this time, when the step S106 has been executed, the output unit 16 outputs the set of output sentences that has been processed. The output is transmission to the terminal device 20. When the set of output sentences is received, the display control unit 22 of the terminal device 20 displays the set of output sentences. As a result, the user can acquire an answer sentence to the question sentence. At this time, a predetermined processing has been performed on a portion of the answer sentence (set of output sentences) that is not based on the related information (in other words, a portion that is highly likely to be a hallucination). Accordingly, when the predetermined processing is deletion processing, it is possible to avoid presenting information that is highly likely to be a hallucination to the user, and to increase the reliability of the set of output sentences. The user may be notified of the presence of the deleted portion so that the user can recognize the deletion. For example, a deletion marker (e.g., a character such as “[]” or a character string such as “deleted here”) may be added to a deleted portion in the generated sentence set, or a deleted portion or a deleted sentence may be generated separately from the set of output sentences and reported to the user. In the following descriptions, a character string displayed as a report separately from the set of output sentences is called a set of deleted character strings. The set of deleted character strings may be generated and output as “deleted portion (such as line number)” and “deleted character string” at the end of the answer sentence, or may be notified by another document. When the predetermined processing is changing the form (a process of changing the form of the corresponding portion in the set of output sentences to a form different from that of the other portions), the user can be notified that the information is highly likely to be a hallucination, and the workload of the user for confirmation can be reduced.

For example, when “Let me know the trivia about pancakes.” is input as the question sentence, “Hot cakes are widely called pancakes in English-speaking countries. January 25 is registered as the day of pancake by the confectionery company.” is retrieved as the related information, and the generation unit 13 generates a set of output sentences which is “It is called a hot cake in Japan, but it is often called a pancake abroad. February 14 is “Hotcake Day.””, then the terminal device 20 displays the following output sentences. In this case, in the generated sentence set, the portion “It is called a hot cake in Japan, but it is often called a pancake abroad.” is a portion that is determined to be based on the related information, with “Hot cakes are widely called pancakes in English-speaking countries.” as the corresponding unit of the related information. Accordingly, in the generated sentence set, the portion “February 14 is “Hotcake Day.”” is a portion that is determined not to be based on the related information.

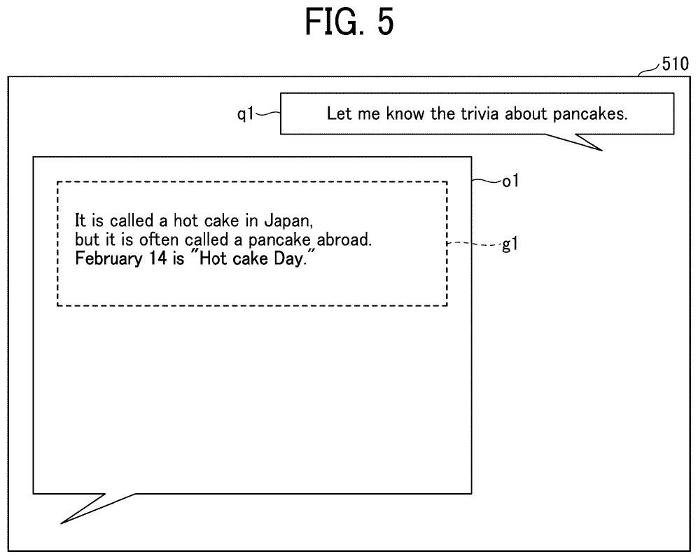

FIG. 5 is a diagram illustrating a first display example of a set of output sentences that has been processed. A set of output sentences display screen 510 illustrated in FIG. 5 includes a question sentence q1, a generated sentence set g1, and a set of output sentences o1. The generated sentence set g1 composes the set of output sentences o1. In FIG. 5, the portion “February 14 is “Hotcake Day.””, which is determined not to be based on the related information in the generated sentence set, is processed in bold.

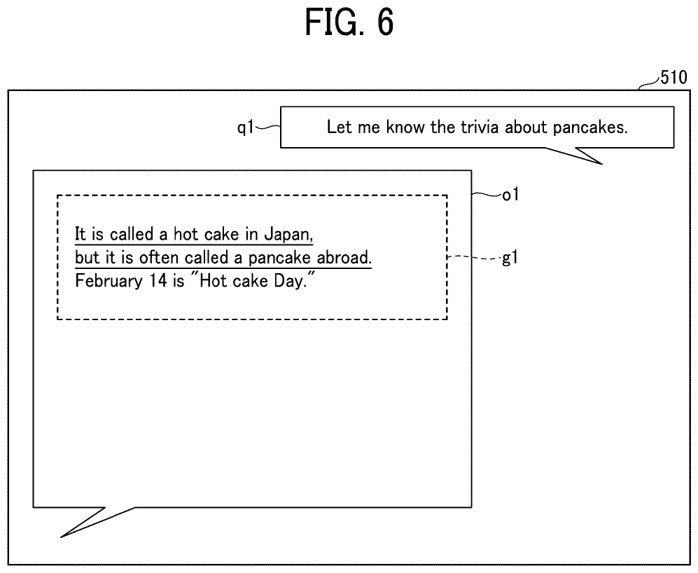

FIG. 6 is a diagram illustrating a second display example of a set of output sentences that has been processed. In FIG. 6, the same or like reference signs are allocated to the same or corresponding portions as those of FIG. 5, and the descriptions thereof are omitted as appropriate. In FIG. 6, the portion “It is called a hot cake in Japan, but it is often called a pancake abroad.”, which is determined not to be based on the related information in the generated sentence set g1, is underlined. The verification unit in this case is a sentence unit.

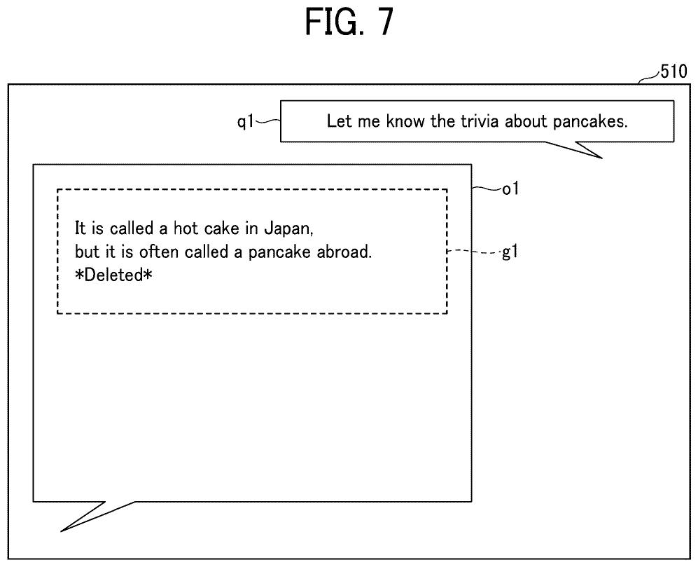

FIG. 7 is a diagram illustrating a third display example of a set of output sentences that has been processed. In FIG. 7, the same or like reference signs are allocated to the same or corresponding portions as those of FIG. 5, and the descriptions thereof are omitted as appropriate. In FIG. 7, the portion “February 14 is “Hotcake Day.””, which is determined not to be based on the related information in the generated sentence set g1, is deleted and the character string “*deleted here*” is added to indicate that the portion has been deleted.

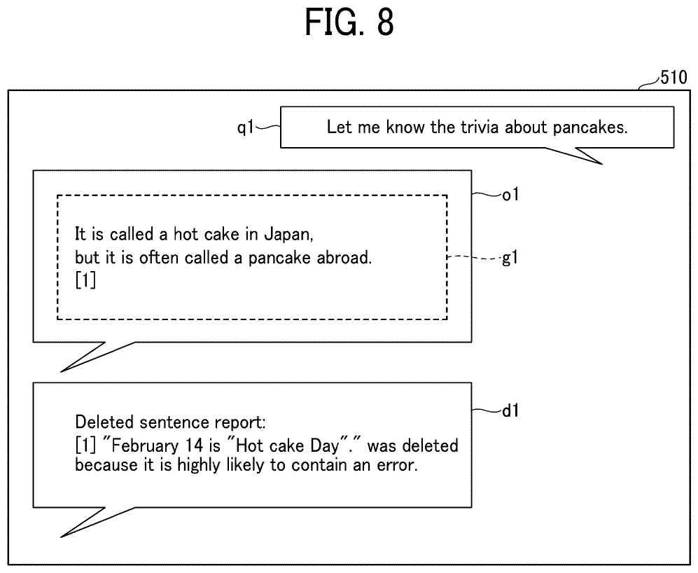

FIG. 8 is a diagram illustrating a fourth display example of a set of output sentences that has been processed. In FIG. 8, the same or like reference signs are allocated to the same or corresponding portions as those of FIG. 5, and the descriptions thereof are omitted as appropriate. The set of output sentences display screen 510 illustrated in FIG. 8 further includes a set of deleted character strings dl for generating a deleted portion or a deleted sentence in the generated sentence set g1 and reporting the generated portion or the deleted sentence to the user. In the generated sentence set g1, the portion “February 14 is “Hotcake Day.””, which is determined not to be based on the related information in the generated sentence set, is deleted and the deleted portion is displayed by a character string “[1]” so that the deletion can be recognized. In order to generate a deleted portion or a deleted sentence and report the deleted portion or the deleted sentence to the user, the set of deleted character strings d1 includes a set of character strings “Deleted sentence report: “February 14 is “Hot cake Day.”” was deleted because it is highly likely to contain an error.”

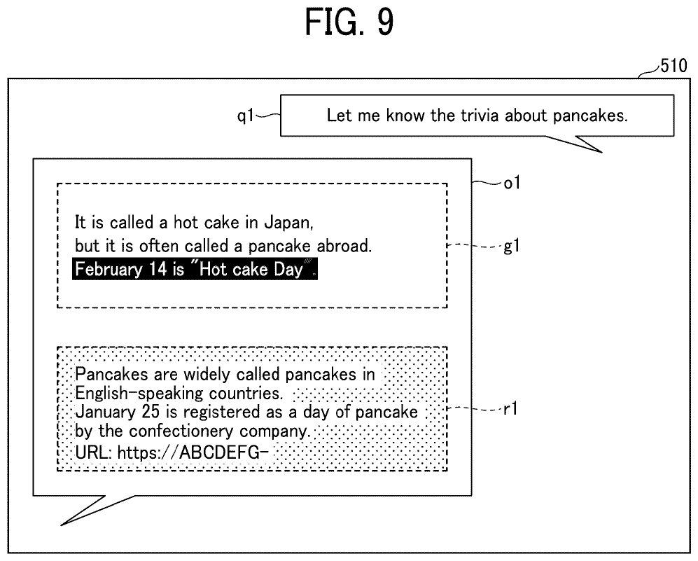

FIG. 9 is a diagram illustrating a fifth display example of a set of output sentences that has been processed. In FIG. 9, the same or like reference signs are allocated to the same or corresponding portions as those of FIG. 5, and the descriptions thereof are omitted as appropriate. In FIG. 9, related information r1 composes the set of output sentences o1 in addition to the generated sentence set g1. The portion “February 14 is “Hotcake Day.”” which is determined not to be based on the related information r1 in the generated sentence set g1, is highlighted.

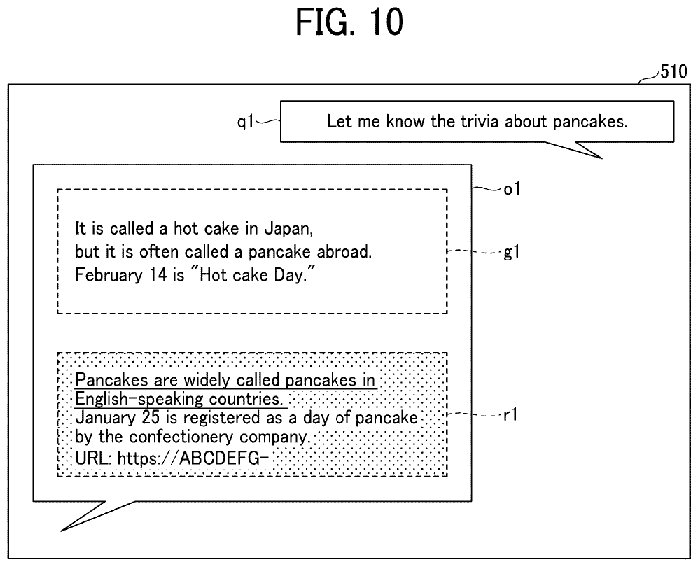

FIG. 10 is a diagram illustrating a sixth display example of a set of output sentences that has been processed. In FIG. 10, the same or like reference signs are allocated to the same or corresponding portions as those of FIG. 9, and the descriptions thereof are omitted as appropriate. In FIG. 10, the portion “Hot cakes are widely called pancakes in English-speaking countries.” is underlined, which is the related information on the portion “It is called a hot cake in Japan, but it is often called a pancake abroad.” The portion “It is called a hot cake in Japan, but it is often called a pancake abroad.” is determined to be based on the related information r1 in the generated sentence set g1.

As described above, according to the present embodiment, it is possible to determine the relevance between a sentence generated based on information and the information and to output based on the determination result.

The apparatuses or devices described in the embodiments described above are merely one example of multiple computing environments that implement the embodiments disclosed herein.

In some embodiments, the sentence generation apparatus 10 includes a plurality of computing devices, such as a server cluster. The multiple computing devices are configured to communicate with one another through any type of communication link including, for example, a network or a shared memory, and perform the processes disclosed in the present specification.

Aspects of the present disclosure are, for example, as follows.
Aspect 1
   A sentence generation apparatus includes a search unit, a generation unit, a determination unit, a processing unit, and an output unit. The search unit searches for related information on an input character string. The generation unit generates a set of sentences based on the character string and the related information. The determination unit determines a relation between the set of sentences and the related information. The processing unit processes a set of output sentences including the set of sentences based on a result of determination of the relation. The output unit outputs the processed set of output sentences.
Aspect 2
   In the sentence generation apparatus according to Aspect 1, the determination is performed for each predetermined unit composing the set of sentences. The processing unit deletes a portion corresponding to a predetermined unit from the set of sentences based on a result of the determination.
Aspect 3
   In the sentence generation apparatus according to Aspect 1, the determination is performed for each predetermined unit composing the set of sentences. The processing unit makes a form of a portion corresponding to a predetermined unit different from a form of another portion in the set of sentences based on a result of the determination.
Aspect 4
   In the sentence generation apparatus according to any one of Aspects 1 to 3, the determination unit performs the determination based on a recognizing textual entailment.
Aspect 5
   In the sentence generation apparatus according to Aspect 2, the output unit notifies a user that there is a deleted portion.
Aspect 6
   An information processing system includes a terminal device and a sentence generation apparatus. The sentence generation apparatus includes a search unit, a generation unit, a determination unit, a processing unit, and an output unit. The search unit searches for related information on a character string input in the terminal device. The generation unit generates a set of sentences based on the character string and the related information. The determination unit determines a relation between the set of sentences and the related information. The processing unit processes a set of output sentences including the set of sentences based on a result of determination of the relation. The output unit outputs the processed set of output sentences to the terminal device.
Aspect 7
   A sentence generation method is executed by a computer. The method includes: searching for related information on an input character string; generating a set of sentences based on the character string and the related information; determining a relation between the set of sentences and the related information; processing a set of output sentences including the set of sentences based on a result of the determining; and outputting the processed set of output sentences.
Aspect 8
   A program causes a computer to perform a method. The method includes: searching for related information on an input character string; generating a set of sentences based on the character string and the related information; determining a relation between the set of sentences and the related information; processing a set of output sentences including the set of sentences based on a result of the determining; and outputting the processed set of output sentences.
   The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.
   The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.
   There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A sentence generation apparatus comprising:
processing circuitry configured to:
search for related information on an input character string;
generate a set of sentences based on the input character string and the related information;
determine a relation between the set of sentences and the related information;
process a set of output sentences including the set of sentences based on a result of the determination; and
output the processed set of output sentences.

2. The sentence generation apparatus according to claim 1, wherein the processing circuitry is configured to
determine the relation for each predetermined unit of the set of sentences, and
delete a portion corresponding to a particular predetermined unit from the set of sentences based on the result of the determination.

3. The sentence generation apparatus according to claim 1, wherein the processing circuitry is configured to
determine the relation for each predetermined unit of the set of sentences, and
makes a form of a portion corresponding to a particular predetermined unit different from a form of another portion of the set of sentences based on the result of the determination.

4. The sentence generation apparatus according to claim 1,
wherein the processing circuitry is configured to perform the determination based on a recognizing textual entailment.

5. The sentence generation apparatus according to claim 2,
wherein the processing circuitry is configured to notify a user that there is a deleted portion.

6. A sentence generation method executed by a computer, the method comprising:
searching for related information on an input character string;
generating a set of sentences based on the input character string and the related information;
determining a relation between the set of sentences and the related information;
processing a set of output sentences including the set of sentences based on a result of the determining; and
outputting the processed set of output sentences.

7. A non-transitory storage medium storing computer-readable program code that, when executed by a computer, causes the computer to perform a method, the method comprising:
searching for related information on an input character string;
generating a set of sentences based on the input character string and the related information;
determining a relation between the set of sentences and the related information;
processing a set of output sentences including the set of sentences based on a result of the determining; and
outputting the processed set of output sentences.
